(19) United States
(12) Patent Application Publication
(10) Pub. No.: US 2005/0288942 A1
(43) Pub. Date: Dec. 29, 2005

(54) Method and apparatus for valuing property

(75) Inventors: Benjamin Graboske, Trabuco Canyon, CA (US); Robert Walker, Tustin, CA (US); Carrie Helbert, Chino Hills, CA (US)

Correspondence Address: Marshall A. Lerner, Esq.;Kleinberg & Lerner, LLP, Suite 1080, 2049 Century Park East, Los Angeles, CA, 90067, US

(73) Assignee: First American Real Estate Solutions, L.P.

(21) Appl. No.: 10/876,421

(22) Filed: Jun. 25, 2004

(51) Int. Cl. G06F 17/60

(52) U.S. Cl. 705/1

(57) ABSTRACT

A method of obtaining valuations of property using multiple automated valuation models to receive the most accurate possible valuation quickly and at the lowest possible cost. An automated decision engine evaluates the accuracy and confidence score of the valuations given by various automated valuation models in a preselected order based upon their ability to provide accurate valuations in a particular geographic region. Additionally, the automated decision engine will provide a response to an individual's loan request to purchase property based on the relevant criteria and the accurate valuation it receives as a result of this method.

### BACKGROUND OF THE INVENTION

1. Field of the Invention

The present invention relates generally to methods and apparatus for valuing property and, more specifically, to a method and apparatus for valuing property based upon an evaluation of the accuracy of valuations given by several automated valuation models and selection of the most accurate valuation.

2. Description of Prior Art

The value of a subject property such as a residential home is a critical piece of information in the lending process. For purposes of this patent application a residential property shall include single-family residences, duplexes and condominiums. The value of the residential property tends to determine the maximum value of the loan that the consumer will be offered.

For the last 40 years, the standard procedure for property valuation has been an appraisal (Uniform Residential Appraisal Report URAR) performed by a licensed appraiser. In the last 5 years or so, things have dramatically changed. There has been a shift away from the use of appraisals and towards the use of Automated Valuation Models (“AVMs”). This is particularly true in the home equity lending segment. Home equity loans tend to be underwritten based more upon the individual's income and credit and less upon the value of the property. The home lending market is also dominated by large banks that generally are not required to have an appraisal for loans under $250,000.

Consequently, some of the largest banks and credit unions in the country have moved away from traditional appraisals because they are too costly and time-consuming relative to their value in the loan underwriting process. In contrast, AVMs are available instantaneously and cost a fraction of traditional appraisals.

This has spurred demand for increasingly accurate AVM valuations. With demand for AVMs growing rapidly, multiple AVM brands have come to the marketplace. Unfortunately, no one AVM brand is clearly the best product in all markets. The astute lender must evaluate AVM brands to determine which brands are acceptable and in which geographic areas and price ranges.

Ideally, a lender would elect to use an AVM in all situations because of speed and cost. Yet in many cases an individual AVM may not meet or exceed loan guidelines in a particular circumstance. In this case, the lender may search for another AVM brand or opt for a traditional appraisal. These “cascading” rules are determined by the individual lender and they are never universal in their application.

In order to take advantage of the cost and time benefits of using AVMs, the lender desires to maximize the “AVM utilization rate.” The AVM utilization rate is the percentage of the time that an AVM can be used in lieu of a traditional appraisal.

The present invention, therefore, provides means by which AVM cascading logic is combined with acceptance logic to maximize AVM utilization subject to the underwriting guidelines of a particular lending institution.

More specifically, the preferred embodiment of this invention addresses the problems of using single automated valuation models to value property by using various automated valuation models against each other in order to produce the most accurate valuation of a property automatically. Using the method of this invention, the user can come away with a numerical value that will represent the confidence level of the valuation of that property and knowing that it met a certain minimum level of accuracy.

The preferred method of this invention combines the best features of both of the prior methods. The cost of performing these additional automated valuation model searches is minimal in comparison to a full appraisal. The valuation can still be completed almost instantly and the accuracy is further assured by the utilization of multiple automated valuation models. This method improves upon the prior art in allowing lenders and other users to depend more upon automated valuation models while further ensuring the accuracy of the valuations and lowering their risks in investment or lending. Therefore, the preferred method of this invention is an improvement in value to the user and in accuracy at providing valuations over the prior art.

### BRIEF SUMMARY OF THE INVENTION

Three principal features are unique to this invention. These features are: the sequencing feature, the acceptance feature and the underwriting rule tracking feature.

The sequencing functionality allows the user to determine the order in which particular AVM brands will be ordered. Some lenders develop AVM sequencing rules based upon one or more of the following: geographic considerations, loan amounts, borrower indicated reference values or appraised values. Generally speaking, whatever rule-set a user may desire in terms of ordering AVMs can be accommodated in the context of the AVM sequencing functionality.

The acceptance feature allows the user to evaluate any AVM result in terms of their underwriting criteria for this loan given the AVM results that have been obtained. The rules used for AVM acceptance vary widely by loan product, consumer credit profile, and estimated loan to value and ultimate investor. In any event, the acceptance rule functionality can accommodate a user's rule-set such that AVM utilization decisions are made on a consistent and unbiased level in each and every transaction. This provides a huge productivity gain for the user. While AVM utilization is clearly the business objective, a lender does not want to “bend the rules” to achieve this goal. Having the acceptance rule functionality insures that the lenders rules will be followed to the letter.

As indicated above, the sequencing rules or the acceptance rules are critically important to the user. From a security perspective the user wants to insure that rule changes are only made by authorized individuals. In addition, there may be good reason to modify rules quickly to respond to particular market circumstances. Consequently, that is the primary reason for the rule tracking functionality. With this feature, authorized users (based upon usernames and pass codes) can make instantaneous changes to the rules of sequence and rules of acceptance. These rule changes are also tracked in a database. Therefore, the user can instantly determine when changes to the sequence or acceptance rules have been made and the identity of the administrator who made the changes. It is also possible to know which rule-set was invoked when a particular property was valued. These are invaluable tools for lenders. This functionality keeps a lender from being forced to engage a programmer from their staff to edit AVM utilization rules.

The ultimate product of any lender is “investment grade” loans. The phrase, “investment grade” means that the ultimate investor can count on the loans to repaid based on the representation that the loans were underwritten to mutually agreeable terms. This invention helps lenders produce investment grade loans by automating the ordering, evaluation and rule tracking of the underwriting guidelines used to judge collateral values as determined by multiple AVMs.

Further features and advantages of the present invention will be appreciated by reviewing the following drawings and detailed description of the invention.

### BRIEF DESCRIPTION OF THE DRAWINGS

FIG. 1 is an overview of the automated decision engine and its interactions with the client system and multiple automated valuation models.

FIG. 2 is a closer view of the interactions between the client system and the automated decision engine.

FIG. 3 is a closer view of the automated decision engine and its internal components

FIG. 4 is a closer view of the interactions between the extended markup language connectors of the automated decision engine and the automated valuation models.

FIG. 5 is a view of the internal components of the rules in the preferred embodiment of the invention.

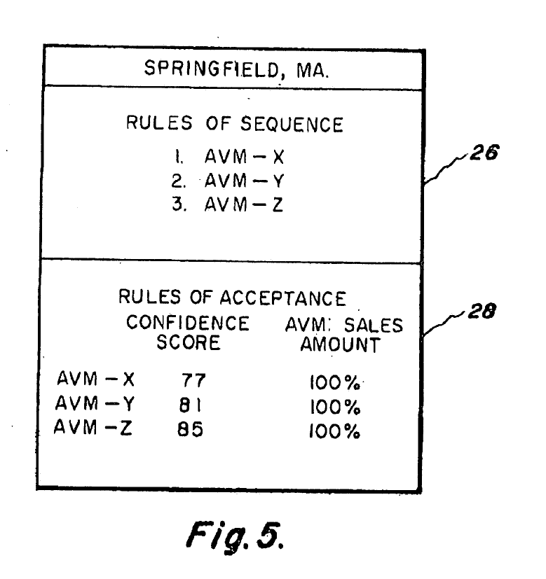

### DETAILED DESCRIPTION OF THE INVENTION

According to the present invention, a method and apparatus are described whereby a decision engine requests multiple automated valuation models in order to achieve an accurate valuation of the prospective property.

In the following description, for the purposes of explanation, specific devices, component arrangements and construction details are set forth in order to provide a more thorough understanding of the invention. It will be apparent to those skilled in the art, however, that the present invention may be practiced without these specifically enumerated details and that the preferred embodiment can be modified so as to provide other capabilities. In some instances, well-known structures and methods have not been described in detail so as not to obscure the present invention unnecessarily.

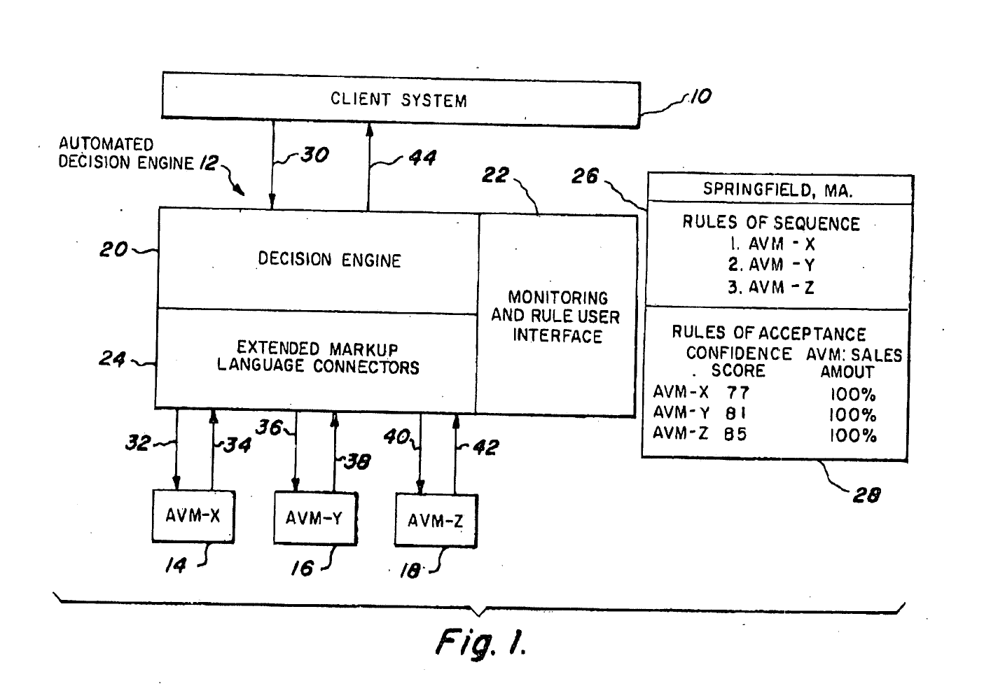

Referring first to FIG. 1, an overview of the preferred embodiment of an automated decision engine 12 is depicted. The automated decision engine 12 is depicted at the center as an intermediary between the client system 10 and the automated valuation models 14, 16 and 18. The automated decision engine 12 is made up of three components, the decision engine 20, the extended markup language (XML) connectors 24 and the monitoring and rule user interface 22. These components make up and perform all of the functions of the automated decision engine 12.

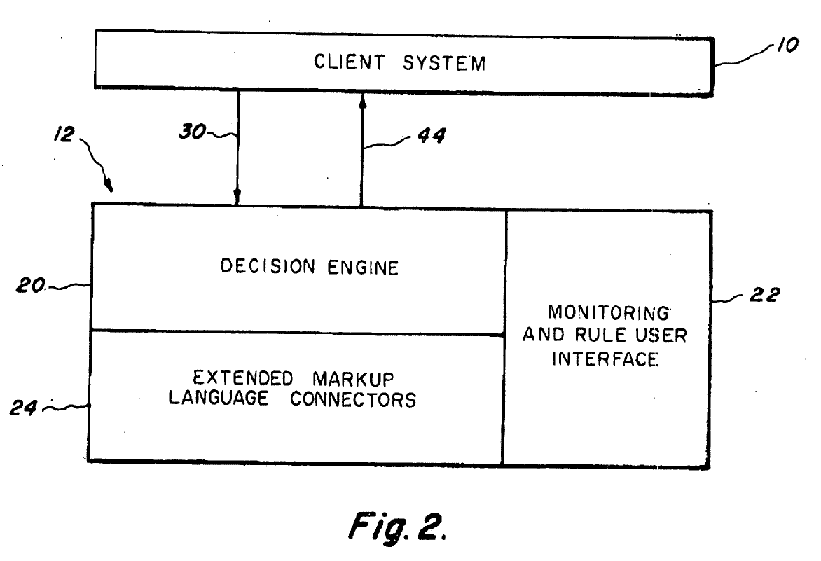

Referring now to FIGS. 1 and 2, a valuation request 30 is made by the client system 10 to the automated decision engine 12 for a valuation of the target property. In the preferred embodiment the valuation request 30 contains an address and the amount requested by the seller for the property. In alternative embodiments, the valuation request 30 may contain a minimum accuracy requirement, a preference for one automated valuation model over another to override the automated decision engine 12's rule-based selection, or other additional request oriented information. As an example of the above process, the client system request could pass a valuation request 30 for the address of 12 Maple Lane, Springfield, Mass. and the sales amount of $327,000 to the automated decision engine 12. This valuation request 30 is designed to provide the automated decision engine 12 with whatever information is necessary to receive a valuation of the target property.

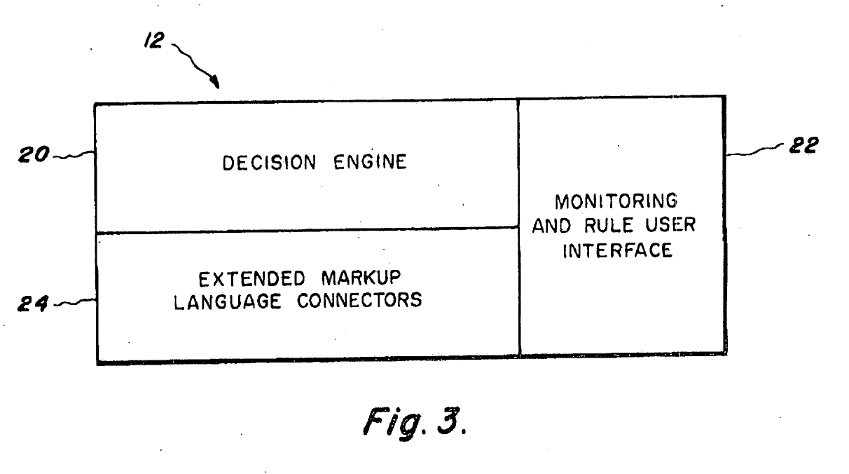

Next, referring to FIGS. 1 and 3, within the automated decision engine 12, the three components begin evaluating the valuation request 30 and acting upon it. The decision engine 20 determines which automated valuation model to request a valuation from first. This decision is made by the decision engine 20 based upon rules of sequence 26 within the monitoring and rule user interface 22. The rules of sequence 26 and the rules of acceptance 28, in the preferred embodiment, are set by the user or an administrator, prior to making the valuation request 30. The rules of sequence 26 and rules of acceptance 28 are very important to the valuation process. Therefore, in the preferred embodiment only those users with proper authority as verified by password or some other form of authentication would be allowed to set them. In the preferred embodiment, the automated decision engine 12 itself will provide the authentication and means by which authorized users can alter the rules of sequence 26 and rules of acceptance 28. Because authentication is required to make changes to these rules, changes to the rules of sequence 26 and the rules of acceptance 28 can be traced to the individual making those changes and to the time when the changes were made. Also, an authenticated user can determine which automated valuation models were consulted and which automated valuation model was used in providing a particular property valuation.

Alternatively, these rules of sequence 26 could be made dynamically over time by the automated decision engine 12 itself after determining in a particular area, over time, that one automated valuation model is more accurate in that area and price range.

Based upon the rules of sequence 26 within the monitoring and rule user interface 22, the decision engine 20 selects which automated valuation model will be used to request the first valuation. As an example, for Springfield Mass. in the given price range, the rules of sequence 26 are: AVM-X, AVM-Y, then AVM-Z; automated valuation models 14, 16, and 18 respectively. Therefore, the decision engine 20 would chose first to request a valuation from AVM-X automated valuation model 14.

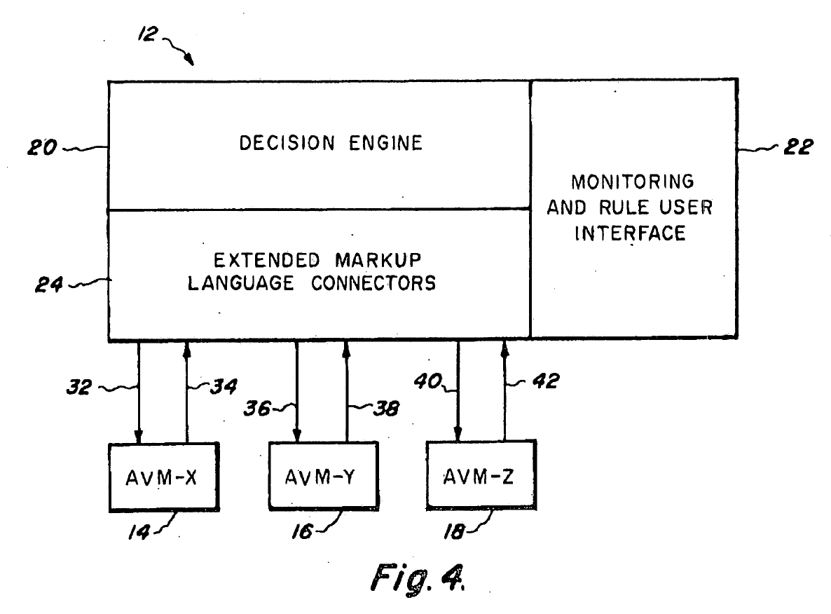

Referring now to FIGS. 1 and 4, the decision engine 20 then passes the valuation request 30 on to the extended markup language (XML) connectors 24 to be formatted for delivery to the chosen automated valuation model. Using the rules of sequence 26, the automated valuation model selected in this geographic region and price range is AVM-X automated valuation model 14. Therefore, the extended markup language (XML) connectors 24 format the information from the valuation request 30 in such a way that AVM-X 14 will accept it as an input request. Once the extended markup language (XML) connectors 24 have formatted the request, they make their own valuation request 32 to AVM-X automated valuation model 14. The AVM-X automated valuation model 14 takes this request, performs a valuation and then returns the valuation and confidence score 34 to the extended markup language (XML) connectors 24. Once this information is returned in extended markup language format, it is reformatted for evaluation by the decision engine 20. Once it has been reformatted, it is passed along as a valuation to the decision engine 20.

Referring again to FIGS. 1 and 3, the valuation and confidence score 34, now formatted for evaluation by the decision engine 20 is first evaluated by the decision engine 20 for validity. If the valuation and confidence score 34 sent to the decision engine 20 is simply a failed valuation request, AVM-X, the automated valuation model 14 was unable to value the property, then the decision engine 20 will make another request to the next automated valuation model in the rules of sequence 26. The decision engine 20 will then move down the rules of sequence 26 to the next automated valuation model, in this case AVM-Y, automated valuation model 16. The decision engine 20 will again pass the information from valuation request 30 to the extended markup language (XML) connectors 24 for formatting to the AVM-Y 16 format. The extended markup language (XML) connectors will then make a valuation request 36 to AVM-Y automated valuation model 16. AVM-Y automated valuation model 16 performs its valuation and returns the valuation and confidence score 38 to the extended markup language (XML) connectors 24. The extended markup language (XML) connectors 24 then reformat this valuation and confidence score 38 into a format that the decision engine 20 can use and pass it along to the decision engine 20.

Referring now to FIGS. 1 and 3, the decision engine 20, then evaluates the valuation and confidence score 38 and using its rules of acceptance 28 within the monitoring and rule user interface 22. In the example, the decision engine 20 determines that the 79% confidence score given by AVM-Y, automated valuation model 16 is not acceptable using the rules of acceptance 28 for AVM-Y automated valuation model 16. The decision engine 20 does not return that valuation. Therefore, the decision engine 20 then determines, using the rules of sequence 26 also found within the monitoring and rule user interface 22, the next automated valuation model in the sequence. Using the rules of sequence 26, the decision engine 20 finds that AVM-Z automated valuation model 18 is the next in the sequence. Should the decision engine 20 find no further automated valuation models, then it would return a valuation response 44 to that effect. Alternatively, should this valuation request 40 also return an unacceptable response, then, were there more automated valuation models within the rules of sequence 26, the decision engine 20 could continue to make requests.

Referring again to FIGS. 1 and 4, the decision engine 20 finds that the third automated valuation model is AVM-Z automated valuation model 18 using the rules of sequence 26 and submits the information from the valuation request 30 to the extended markup language (XML) connectors 24. Again, the information from the valuation request 30 is formatted for use by AVM-Z automated valuation model 18 and is passed to AVM-Z automated valuation model 18 as valuation request 40. AVM-Z automated valuation model 18 then performs a valuation and returns the valuation and confidence score 42 in extended markup language (XML) format to the extended markup language (XML) connectors 24. These extended markup language (XML) connectors 24 reformat the information for use by the decision engine 20. The decision engine 20 first determines that the value given by AVM-Z automated valuation model 18 is valid. Next the decision engine 20 evaluates the valuation given by AVM-Z automated valuation model 18 and determines that the value is acceptable based upon the criteria given in valuation request 30. In the example, the valuation returned is $331,000 with a confidence score of 86%. In the preferred embodiment the decision engine 20 determines if the $310,000 value returned in the valuation and confidence score 42 is high enough to approve the loan and if under the rules of acceptance 28 for AVM-Z automated valuation model 18, the confidence score of 86% returned is also high enough for acceptance. In the example, it is high enough in value when under the rules of acceptance 28.

Referring again to FIGS. 1 and 2 once the valuation and confidence score returned by one of the automated valuation models is acceptable, the decision engine 20 within the automated decision engine 12 will return a valuation report 44 to the client system 10. In the preferred embodiment this report will include the acceptable valuation, a confidence score, and the decision made by the decision engine 20. In the example, this would return a valuation report 44 including: a direction to accept the loan request, a valuation of the property, and the confidence score returned by the automated valuation model whose valuation was accepted. Additionally, the automated decision engine 12 could return the non-accepted automated valuation model's valuations, the list of automated valuation models consulted, the rules used in accepting the valuation request.

The actions of the automated decision engine 12 are completely invisible to the end user. The entirety of this process will generally take from a few seconds to a few minutes and the user will only submit the request and receive the results. So far as the user is concerned, the internal decisions made by the automated decision engine 12, the rules of acceptance 28 and the rules of sequence 26 are completely invisible.

It will be apparent to those skilled in the art that the foregoing description is for illustrative purposes only, and that various changes and modifications can be made to the present invention without departing from the overall spirit and scope of the present invention. The full extent of the present invention is defined and limited only by the following claims.

1. A method of utilizing multiple automated valuation models to value a property comprising the steps of:
requesting a valuation from an automated decision engine;
selecting the automated valuation model from which to request the valuation based upon a predetermined priority;
requesting said valuation from said automated valuation model;
receiving said valuation from said automated valuation model;
evaluating said valuation received from said automated valuation model;
repeating said steps of selecting and requesting from an alternative automated valuation model if said valuation is not acceptable based upon a predetermined criteria; and
returning a response from said automated decision engine based upon said predetermined criteria.

2. The method of claim 1, wherein said predetermined criteria is a minimum valuation before the issuance of a loan.

3. The method of claim 1, wherein said predetermined criteria is a requirement of a minimum confidence score.

4. The method of claim 1, wherein said predetermined priority is a predetermined ordering of said automated valuation models in a given geographic region.

5. The method of claim 1, wherein said predetermined priority is a predetermined ordering of said automated valuation models in a given price range.

6. The method of claim 1, wherein said predetermined priority is an arbitrary ordering of said automated valuation models in a given geographic region.

7. The method of claim 1, wherein said predetermined priority is an arbitrary ordering of said automated valuation models in a given price range.

8. The method of claim 1, wherein the receiving step further includes the receiving of a confidence score as to the accuracy of said valuation.

9. The method of claim 1, wherein said predetermined criteria is a requirement of a certain confidence score or above.

10. The method of claim 1, wherein said predetermined criteria is a requirement of a certain confidence score or above determined based upon the automated valuation model from which said valuation is requested.

11. The method of claim 2, wherein said predetermined priority is a predetermined ordering of said automated valuation models in a given geographic region.

12. The method of claim 2, wherein said predetermined priority is a predetermined ordering of said automated valuation models in a given price range.

13. The method of claim 3, wherein said predetermined priority is a predetermined ordering of said automated valuation models in a given geographic region.

14. The method of claim 3, wherein said predetermined priority is a predetermined ordering of said automated valuation models in a given price range.

15. The method of claim 4, wherein said predetermined criteria is a minimum valuation before the issuance of a loan.

16. The method of claim 4, wherein said predetermined criteria is a requirement of a minimum confidence score.

17. The method of claim 5, wherein said predetermined criteria is a minimum valuation before the issuance of a loan.

18. The method of claim 5, wherein said predetermined criteria is a requirement of a minimum confidence score.

19. The method of claim 6, wherein said predetermined criteria is a minimum valuation before the issuance of a loan.

20. The method of claim 6, wherein said predetermined criteria is a requirement of a minimum confidence score.

21. The method of claim 7, wherein said predetermined criteria is a minimum valuation before the issuance of a loan.

22. The method of claim 7, wherein said predetermined criteria is a requirement of a minimum confidence score.

23. The method of claim 8, wherein the returning step further includes the returning of a confidence score as to the accuracy of said valuation.

24. A computer-based apparatus for valuing a subject property comprising:
a client system;
an automated decision engine connected to said client system comprising a decision engine, extended markup language connectors, and a monitoring and rule user interface; and
a plurality of automated valuations models connected to said automated decision engine.

25. The apparatus of claim 24 wherein said monitoring and rule user interface operates according to:
computer data-based rules of sequence; and
computer data-based rules of acceptance.

26. The apparatus of claim 25 wherein said rules of sequence and rules of acceptance are set by an authorized user.

27. The apparatus of claim 24 wherein said monitoring and rule user interface is capable of logging changes to said computer data-based rules of sequence and said computer data-based rules of acceptance by said authorized user.

28. The apparatus of claim 25 wherein said monitoring and rule user interface is capable of logging changes to said computer data-based rules of sequence and said computer data-based rules of acceptance by said authorized user.

29. The method of claim 1 wherein said predetermined priority is changeable by a user and changes to said predetermined priority are logged by said automated decision engine.

30. The method of claim 1 wherein said predetermined priority is changeable by a user and the user who changes said predetermined priority is logged by said automated decision engine.

31. The method of claim 1 wherein said returning step further includes logging the automated valuation model used to make the decision.

32. The method of claim 1 wherein said predetermined criteria are changeable by a user and changes to said predetermined criteria are logged by said automated decision engine.

33. The method of claim 1 wherein said predetermined criteria are changeable by a user and the user who changes said predetermined criteria is logged by said automated decision engine.

34. The method of claim 1 wherein said predetermined priority is changeable and authentication is required to change said predetermined priority.

35. The method of claim 1 wherein said predetermined criteria is changeable and authentication is required to change said predetermined criteria.
